(19) United States
(12) Patent Application Publication
(10) Pub. No.: US 2012/0016687 A1
(43) Pub. Date: Jan. 19, 2012

(54) METHOD AND APPARATUS FOR QUALITY CONTROL OF ELECTRONIC PRESCRIPTIONS

(75) Inventors: Ajit A. Dhavle, Alexandria, VA (US); David Yakimischak, Brookside, NJ (US)

(73) Assignee: Surescripts, Alexandria, VA (US)

(21) Appl. No.: 12/836,205

(22) Filed: Jul. 14, 2010

(51) Int. Cl. G06Q 50/00; G06F 17/30; G06Q 10/00

(52) U.S. Cl. 705/2; 707/758; 707/E17.009

(57) ABSTRACT

Apparatuses, methods, and computer readable medium for quality control checking of electronic prescriptions. The method including receiving an electronic prescription; determining whether or not the electronic prescription meets a quality standard for each of a plurality of quality issues and marking a scorecard to indicate whether or not the electronic prescription meets the quality standard for each of the plurality of quality issues; and if the scorecard indicates the electronic prescription meets a minimum quality standard then forwarding the electronic prescription for fulfillment, otherwise if the scorecard indicates the electronic prescription does not meet a minimum quality standard forwarding the electronic prescription for review.

### FIELD

The present disclosure relates to quality control checking and more particularly to quality control checking of an electronic prescription.

### BACKGROUND

In the discussion of the background that follows, reference is made to certain structures and/or methods. However, the following references should not be construed as an admission that these structures and/or methods constitute prior art. Applicants expressly reserve the right to demonstrate that such structures and/or methods do not qualify as prior art.

Electronic prescribing of pharmaceuticals improves productivity for the prescriber, the patient, and the pharmacist. In electronic prescribing the prescriber, for example a doctor, fills out a prescription on a computer and sends the prescription to a pharmacy for fulfillment. The prescriber may benefit by having a computer program assist the doctor in filling out the prescription and by having an electronic record of the prescription prescribed to the patient. The patient may benefit by not having to call the pharmacist or wait at the pharmacy while the prescription is being fulfilled. Additionally, electronic prescribing can enhance patient care by improving patient safety and increased cost savings. The pharmacist may benefit because the electronic prescription may be easier to understand than a doctor's handwriting and because the pharmacist may not have to confirm the prescription with the prescriber. Additionally, the pharmacist may have an electronic record of the prescriptions that the pharmacy has fulfilled without having to key in the prescription. Studies indicate that patients are more likely to fulfill a prescription and take the pharmaceuticals when the prescription is fulfilled using electronic prescribing.

Although standards for electronic prescribing have been implemented, some of the data in electronic prescriptions do not have a standardized format and some of the data in an electronic prescription may be free text that is entered by a prescriber. For example, the prescriber may type in the free text. Additionally, the prescriber may make errors such as choosing the wrong medication or typing in the wrong patient directions. There is a danger that a patient will receive the wrong pharmaceutical or the wrong dosage of the pharmaceutical, or that the pharmacist will not be able to fulfill the prescription.

### SUMMARY

A method on a computer for quality control checking of electronic prescriptions is described. The method including receiving from a computer network an electronic prescription, determining whether or not the electronic prescription meets a quality standard for each of a plurality of quality issues and generating a quality scorecard to indicate whether or not the electronic prescription met the quality standard for each of the plurality of quality issues; and if the scorecard indicates the electronic prescription meets a minimum quality standard then forwarding the electronic prescription across a computer network for fulfillment, otherwise if the scorecard indicates the electronic prescription does not meet a minimum quality standard forwarding the electronic prescription for review.

A computer program product is described. The computer program product including a computer-readable medium including a first set of codes for receiving from a computer network an electronic prescription; a second set of codes for determining whether or not the electronic prescription meets a quality standard for each of a plurality of quality issues; a third set of codes for generating a quality scorecard to indicate whether or not the electronic prescription met the quality standard for each of the plurality of quality issues; and a fourth set of code for forwarding the electronic prescription across a computer network for fulfillment, if the scorecard indicates the electronic prescription meets a minimum quality standard, a fifth set of code for forwarding the electronic prescription for review, if the scorecard indicates the electronic prescription does not meet a minimum quality standard.

A computer system for quality control checking of electronic prescriptions is provided. The computer system including a process adapted to: receive from a computer network an electronic prescription; determine whether or not the electronic prescription meets a quality standard for each of a plurality of quality issues; generate a quality scorecard to indicate whether or not the electronic prescription met the quality standard for each of the plurality of quality issues; forward the electronic prescription across a computer network for fulfillment if the scorecard indicates the electronic prescription meets a minimum quality standard; and forward the electronic prescription for review, if the scorecard indicates the electronic prescription does not meet a minimum quality standard.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 is an illustration of an example of a system for quality control.

FIG. 2 illustrates an example of a method of the quality control system.

FIG. 3 illustrates an example of an electronic prescription.

FIG. 4 illustrates an example of a drug product in a drug product database.

FIG. 5 illustrates an example of a synonym in a synonym database.

FIG. 6 illustrates an example of a method to match an electronic prescription with a drug product in a drug product database.

FIG. 7 illustrates an example of a method for determining whether or not the electronic prescription meets a quality standard for each of a plurality of quality issues and generating a quality scorecard to indicate whether or not the electronic prescription met the quality standard for each of the plurality of quality issues.

FIG. 8 is a simplified functional block diagram of a computer system.

### DETAILED DESCRIPTION

There is a need in the art for an apparatus and method for quality control checking of electronic prescriptions. The method including receiving an electronic prescription; determining whether or not the electronic prescription meets a quality standard for each of a plurality of quality issues and marking a scorecard to indicate whether or not the electronic prescription met the quality standard for each of the plurality of quality issues; and if the scorecard indicates the electronic prescription meets a minimum quality standard then forwarding the electronic prescription for fulfillment, otherwise if the scorecard indicates the electronic prescription does not meet a minimum quality standard forwarding the electronic prescription for review.

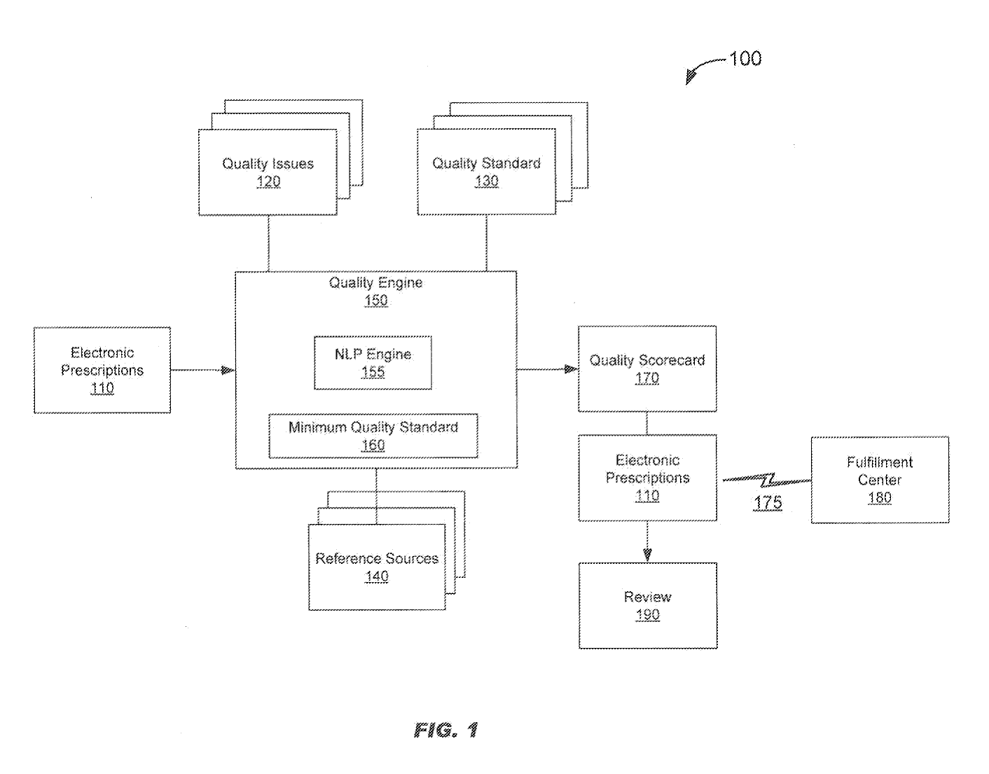

FIG. 1 is an illustration of an example of a quality control system. The quality control system 100 includes an electronic prescription 110, quality issues 120, quality standards 130, reference sources 140, quality engine 150, a natural language processing (NLP) engine 155, minimum quality standard 160, quality scorecard 170, fulfillment center 180, and review 190. The quality engine 150 receives an electronic prescription 110 and determines whether or not the electronic prescription 110 meets quality standards 130 for each of a plurality of quality issues 120 using reference sources 140, and generates a quality scorecard 170 to indicate whether or not the electronic prescription 110 meets the quality standard 130 for each of the plurality of quality issues 120. The quality engine 150 may forwarded the electronic prescription 110 for fulfillment 180 and/or may forward the electronic prescription 110 for review 190 if the electronic prescription 110 does not meet a minimum quality standard 160. Actions the quality engine 150 may take on the electronic prescription 110 are described more fully below.

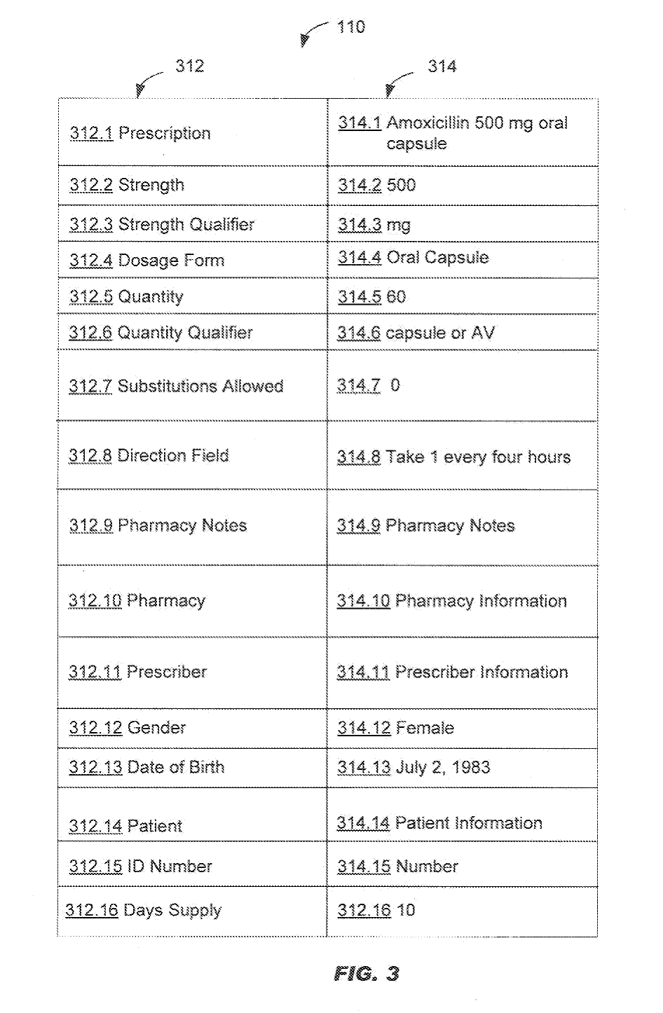

The electronic prescription 110 is a collection of data fields that may include a prescription, strength, strength qualifier, dosage form, quantity, quantity qualifier, substitutions allowed, direction field, pharmacy notes, pharmacy, prescriber, gender, age, patient. Some of the fields may be free text (for example typed in by a prescriber) and other fields may be chosen from a limited number of choices, for example from a pull down menu. The data fields are described in more detail in relation to FIG. 3. The electronic prescription 110 may be a prescription or a refill prescription. The electronic prescription 110 may be received from a prescriber technology vender (not illustrated) or from the prescriber (not illustrated.)

The quality issues 120 may include whether or not a drug description field of the electronic prescription includes a drug name that can be matched to a drug product in a database of drug products in one of the reference sources 140. If a match can be found then additional fields of the matched drug product in the database of drug products may be used for additional quality issues. The matched drug product may include a National Drug Code (NDC) System 11-digit number that describes the drug product. The quality issues 120 may further include whether or not additional fields of the electronic prescription 110 are consistent with additional fields of the matched drug product. The quality issues 120 may further include whether or not the fields of the electronic prescription 110 are consistent with one another. The quality issues 120 may include whether or not a substitutions allowed field of the electronic prescription is consistent with the drug name of the electronic prescription 110. The quality issues 120 may include whether or not the electronic prescription 110 is appropriate for the patient based on demographic information of the patient. Demographic information for the patient may be available as part of the electronic prescription 110. The quality issues 120 may include whether or not pharmacy information included with the electronic prescription 110 is consistent with pharmacy information that is part of the reference sources 140. The quality issues 120 may include whether or not prescriber information included with the electronic prescription 110 is consistent with prescriber information that may be part of the reference sources 140. The quality issues 120 may include verifying that quantity and dosage information included with the electronic prescription 110 is consistent with quantity and dosage information for the drug product that is part of the references sources 140. The quality issues 120 may include verifying that a direction field with the electronic prescription 110 is consistent with what a direction field should contain based on information in the reference sources 140. The quality issues 120 may include verifying that a pharmacy notes field with the electronic prescription 110 is consistent with what a pharmacy notes field should contain based on information in the reference sources 140. In embodiments, the quality issues 120 may be separate rules that are read and interpreted by the quality engine 100. In embodiments, the quality issues 120 may be directly coded into the logic of the quality engine 100.

The quality standards 130 are quality standards 130 that may be used to determine whether or not an electronic prescription 110 satisfies quality issues 120. For example, a quality standard 130 may be that an electronic prescription 110 must match a drug product in the reference sources 140. Additional examples of quality standards 130 are provided below. In embodiments, the quality standards 130 may be separate rules that are read and interpreted by the quality engine 100. In embodiments, the quality standards 130 may be directly coded into the logic of the quality engine 100.

The reference sources 140 may include a database of drug products; clinical decision support information; demographic information of pharmacies and fulfillment centers; demographic information of prescribers; a database of rules and template examples for free-text fields and, a synonym database. The clinical decision support information may be a set of rules that indicates permissible or impermissible prescriptions. For example, a rule of the clinical decision support information may be that if a patient is a female then a drug should not be given to the patient; or that if a patient is less than 2 years old then a dosage should not be given to the patient above a certain amount for a certain drug. The reference sources 140 may be directly available or may be remotely accessible. For example, the reference sources 140 may be stored on a local computer hard drive or the reference sources 140 may be accessible over a computer network that may be either local or remote such as the Internet.

The minimum quality standard 160 may be compared with the quality scorecard 170 to determine what to do with the electronic prescription 110. The quality engine 150 may do one or more of the following based on the comparison: forward the electronic prescription 110 across a computer network for fulfillment 180, forward the electronic prescription 110 for review 190, forward the electronic prescription across a computer network for fulfillment 180 with an indication that the electronic prescription 110 did not meet some quality standards 130, forward the electronic prescription 110 back to at least one of the prescriber or a prescriber technology vender with an indication that the electronic prescription 110 did not meet some quality standards 130, forward the electronic prescription 110 to a pharmacy technology vender with an indication that the electronic prescription 110 did not meet some quality standards 130, and forward the electronic prescription 110 in real time for review by an expert to assess whether or not to forward the electronic prescription 110 for fulfillment 180. Not meeting some quality standards 130 in this context means that one or more of the quality issues 120 applied to the electronic prescription 110 by the quality engine 150 did not meet a quality standard 130 for the electronic prescription 110.

The minimum quality standard 160 is used to determine what action to take on the electronic prescription 110 based on which of the quality standards 130 were met or not met. In embodiments, the minimum quality standard 160 may be a rule or rules. For example, the minimum quality standard 160 may be a rule that if a drug name in the electronic prescription 110 cannot be matched to a drug product database in the reference sources 140 then the electronic prescription 110 should be forwarded for fulfillment with an indication that the drug name in the electronic prescription 110 could not be matched with a drug product.

The quality scorecard 170 is data that indicates the result of applying the quality standards 130 to the quality issues 120. For example, the quality scorecard 170 may be data that indicates that a drug name of the electronic prescription 110 did not match a drug product in a drug product database of the reference sources 140. In this case the quality issue 120 is whether or not the drug name of the electronic prescription 110 matches a drug product in the drug product database of the reference sources 140, and the quality standard 130 is that the drug name of the electronic prescription 110 must match a drug product in the drug product database. In embodiments, synonyms may be used for the drug name of the electronic prescription 110 and/or the drug products of the reference sources 140 in matching the drug name of the electronic prescription 110 to the drug product database of the reference sources 140. In embodiments, the quality scorecard 170 may not be explicitly generated, but may be implicit in the logic of the quality control system 100. For example, the quality engine 150 may be hard coded to forward an electronic prescription 110 for review 190, if the quality engine 150 cannot find a match between the electronic prescription 110 and a drug product in the drug product database.

Fulfillment center 180 is a place where the electronic prescription 110 may be sent and fulfilled. An example of a fulfillment center 180 is an authorized pharmacy. The electronic prescription 110 may be sent to a fulfillment center technology vender (not illustrated) and then to the fulfillment center 180.

Review 190 indicates that the electronic prescriptions 110 is forwarded for review. The review may be by an expert such as a pharmacist or medical doctor to review the quality scorecard 170. In embodiments, the review 190 may simply return the electronic prescription 110 to the prescriber without reviewing the electronic prescription 110. In embodiments, an expert may determine that the electronic prescription 110 may be sent to the fulfillment center 170. In embodiments, an indication that the electronic prescription 110 did not meet some quality standards 130 may be included with the electronic prescription 110. In embodiments, the review 190 may indicate that the electronic prescription 110 is reviewed and becomes part of a report for providing feed-back to the prescriber technology vender and/or the prescriber. The prescriber technology vender and/or the prescriber may use the reports for improving future electronic prescriptions 110.

In embodiments, the quality engine 150 is a computer module. The quality engine 150 may be a single computer module or a number of cooperating computer modules. The quality engine 150 may be configured to receive an electronic prescription 110, and determine whether or not the electronic prescription 110 meets a quality standard 130 for each of a plurality of quality issues 120, and generate a quality scorecard 170 to indicate whether or not the electronic prescription 110 met the quality standard 130 for each of the plurality of quality issues 120.

In embodiments, the quality engine 150 includes a NLP engine 155. The NLP engine 155 may use the reference sources 140 to parse fields of the electronic prescription 110 for syntactic and/or semantic content. The NLP engine 155 may use the database of rules and template examples for free-text fields, which may be part of the reference sources 140, to parse fields of the electronic prescription 110 for syntactic and/or semantic content.

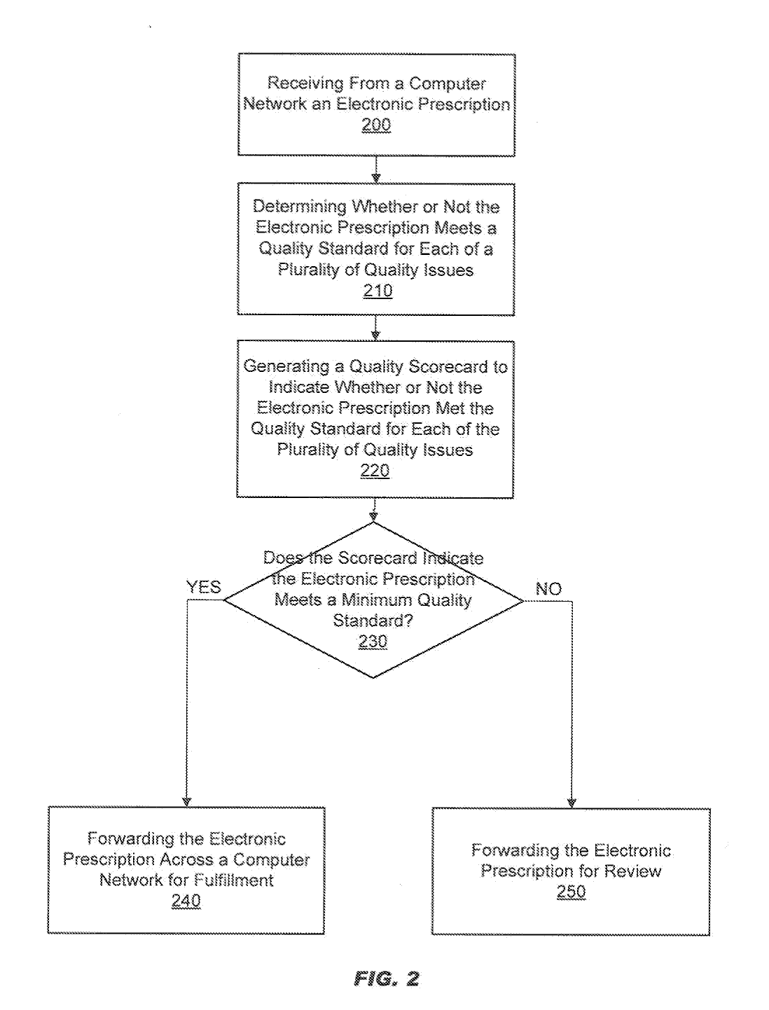

FIG. 2 illustrates an example of a method of the quality control system 100. The method begins with receiving from a computer network an electronic prescription 200. For example, referring to FIG. 1, the quality engine 100 receives an electronic prescription 110 from across a computer network. The quality engine 150 may receive the electronic prescription 110 directly from a prescriber such as a hospital or doctor's office or may receive the electronic prescription 110 indirectly through a third-party such as a prescriber technology vender. The method continues with determining whether or not the electronic prescription meets a quality standard for each of a plurality of quality issues 210. For example, referring to FIG. 1, the quality engine 150 determines whether the received electronic prescription 110 meets quality standards 130 for each of a plurality of quality issues 120. The method continues with generating a quality scorecard to indicate whether or not the electronic prescription met the quality standard for each of the plurality of quality issues 220. Continuing to refer to FIG. 1, the quality engine 150 generates a scorecard 170 that indicates whether or not the electronic prescription 110 met the quality standard 130 for each of the plurality of quality issues 120. For example, the quality engine 150 matches the electronic prescription 110 to a drug product in the reference sources 140. The quality issue 120 is whether or not the electronic prescription 110 matches a drug product, and the quality standard 130 may be that the electronic prescription 110 must match a drug product. The quality scorecard 170 indicates whether or not the drug name matched a drug product or not. In embodiments, the quality engine 150 may not explicitly generate a quality scorecard 170. For example, the quality engine 150 may attempt to match the electronic prescription 110 to a drug product and when no match is found the quality engine 100 may forward the electronic prescription 110 for review 190 without explicitly generating a quality scorecard 170. The method continues with determining whether the scorecard indicates the electronic prescription meets a minimum quality standard 230. For example, continuing to refer to FIG. 1, the quality scorecard 170 is examined to determine whether or not the electronic prescription 110 meets a minimum quality standard 150. For example, the quality scorecard 170 may be examined to determine whether or not a match was found between the electronic prescription 110 and a drug product of the reference sources 140. The quality engine 150 may then use the minimum quality standard 160 to determine whether or not finding a match between the drug name and the drug product indicates that the electronic prescription 110 meets a minimum quality standard 160. When the quality scorecard 170 indicates that the electronic prescription 110 meets a minimum quality standard 160 then the method continues with forwarding the electronic prescription across a computer network for fulfillment 240. Continuing to refer to FIG. 1, the quality engine 150 may determine that the electronic prescription 110 did meet the minimum quality standard 160. For example, if a match was found between the electronic prescription 110 and the drug product of the reference sources 140, then the minimum quality standard 160 may indicate that the electronic prescription 110 meets the minimum quality standard 160. When the quality scorecard 170 indicates that the electronic prescription 110 does not meet a minimum quality standard 160 then the method continues with forwarding the electronic prescription for review 250. Continuing to refer to FIG. 1, for example, if a match was not found between the drug name of the electronic prescription 110 and a drug product in the reference sources 140, then the minimum quality standard 160 may indicate that the electronic prescription 110 does not meet the minimum quality standard 150 and the quality engine 150 may forward the electronic prescription 110 for review 190. In embodiments, step 250 may include the quality engine 150 forwarding the electronic prescription for fulfillment. In embodiments, step 250 may include the quality engine 150 including with the electronic prescription 110 an indication that the electronic prescription did not meet at least one quality standard. The method may repeat for additional electronic prescriptions 110.

FIG. 3 illustrates an example of an electronic prescription. The electronic prescription 110 may include a number of data fields 312 which may be named and may have values for the data fields 314. Some of the fields 312 may be optional and other fields 312 may be required. For example, illustrated in FIG. 3 is “Prescription” 312.1 which has a value of “Amoxicillin 500 mg oral capsule” 314.1. The field prescription 312.1 may be populated in a number of ways. For example, it may be populated by free text where a prescriber types in the prescription, or it may be populated by a prescriber selecting from a drop down menu of options, or it may be populated by a prescriber selecting from a drop down menu of options for each of the subfields (for example drug name, strength, and dosage form) and the software compiling the subfields together. Other fields may be optional. For example, “Strength” 312.2 with a value of “500” 314.2 may be optional. The “Strength” 312.2 and other fields may be redundant to information included in other fields. For example as illustrated, “500” 314.2 is redundant to “Amoxicillin 500 mg oral capsule.” The electronic prescription 110 may also include “Strength Qualifier” 312.3 with value “mg” 314.3. The electronic prescription 110 may include “Dosage Form” 312.4 with a value of “Oral Capsule” 314.4. The electronic prescription 110 may include “Quantity” with a value of “60” 214.5. The “Quantity” may be the quantity of “oral capsule” for the prescription in this case “500 mg oral capsule.” The electronic prescription 110 may include “Quantity Qualifier” 312.6 with a value of “capsule” or “AV” 314.6 (“AV” is a term of art meaning capsule). The electronic prescription 110 may include “Substitutions Allowed” 312.7 with a value “0” 314.7. The “Substitutions Allowed” 312.7 may be a required field that indicates whether or not a generic may be substituted for a brand named prescription. A value “1” 314.7 may indicate that substitutions are not allowed, but in this case Amoxicillin is a generic drug, and the field may only be applicable when the drug name indicates a brand name drug. The electronic prescription 110 may include “Direction Field” 312.8 with a value “Take 1 every four hours” 314.8. The “Direction Field” 312.8 may be a field that indicates what directions should be printed on the label of the prescription for the patient to follow. The electronic prescription 110 may include “Pharmacy Notes” 312.9. The “Pharmacy Notes” 312.9 may be an optional field that provides the pharmacy or fulfillment center with notes to the pharmacist. The electronic prescription 110 may include “Pharmacy” 312.10 which may include information that identifies a pharmacy or fulfillment center. The electronic prescription 110 may include “Prescriber” 312.11 which may include information that identifies a prescriber. The electronic prescription 110 may include “Gender” 312.12 which may be an optional field that includes the gender of the patient. The electronic prescription 110 may include “date of birth” 312.13 which may be an optional field that includes information indicating the age of the patient. The electronic prescription 110 may include “Patient” 312.14 which may include information that can be used to identify the patient. The electronic prescription 110 may include “ID Number” 312.15 with a value “Number” 314.15. The ID Number may be a number that identifies the drug product intended to be used to fulfill the prescription such as a National Drug Code (NDC) System number. The electronic prescription 110 may include “Days Supply” 312.16 with a value “10” 314.16, which indicates that the prescription is meant to be for a “10” day supply. The above are illustrative examples of data fields 312 that may be included in an electronic prescription 110. The electronic prescription 110 may include other data fields 312.

Some fields may be selected from a limited number of options. For example, field 312.12 “Gender” may have only two possible selections of “Male” or “Female.” Other fields may be entered free text as described above. Moreover, the quality engine 150 may access information in the reference sources 140 based on values of some of the fields. For example, the quality engine 150 may verify that the Prescriber 312.11 is a registered prescriber 312.11 in a database of prescribers that may be included in the references sources 140. In embodiments, the electronic prescription 110 may not be organized together, but may be grouped separately.

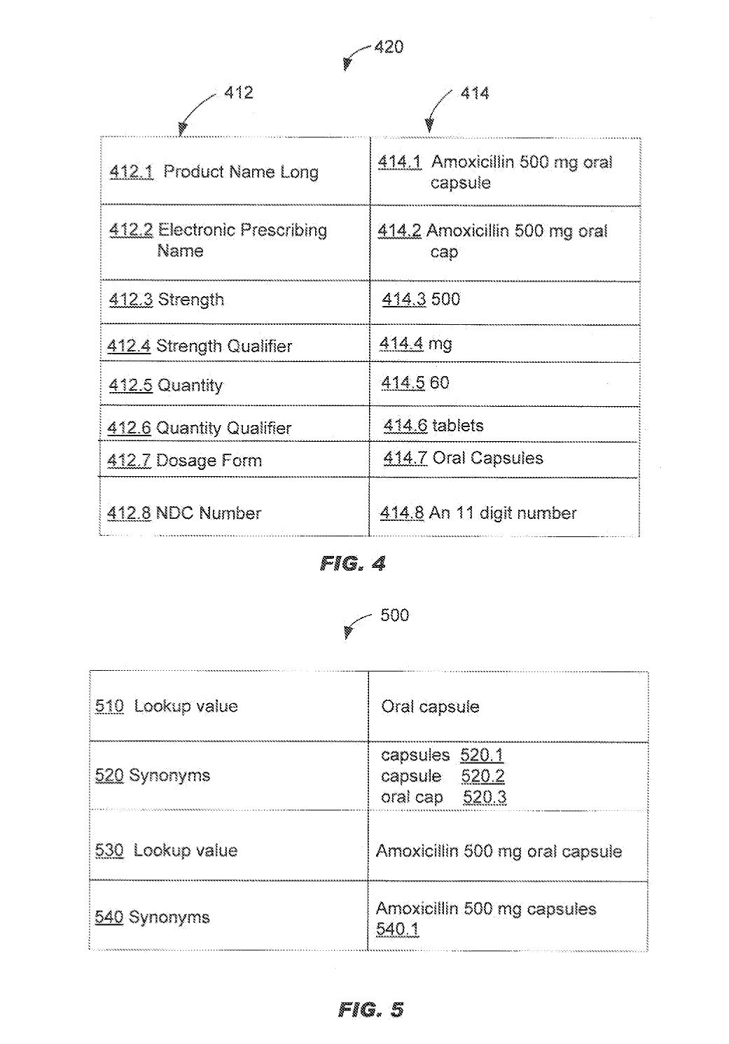

FIG. 4 illustrates an example of a drug product. The references sources 140 (see FIG. 1) may include a database of drug products 420. The database of drug products may be a database provided by a third party supplier of information regarding drug products. Each of the drug products 420 may be a collection of data or fields. Each of the drug products 420 may be a description of a drug product that may be identified by a National Drug Code (NDC) System number. Each of the drug products 420 may include the following fields. A full drug description field 412.1 may be a field that includes a full description of the prescription, “Amoxicillin 500 mg oral capsule” 414.1. An electronic prescribing name 412.2 may be a description of the drug product 420 that may be used in an electronic prescription, “Amoxicillin 500 mg oral cap” 412.2. The electronic prescribing name 412.2 may not be included in the database of drug products 420 and may be a synonym for the full drug description field 412.1. A strength 412.3 may be a strength of the drug product 420. For example, “500” 414.3. A strength qualifier 412.4 may be a qualifier for the strength. For example, “mg” 414.4. A quantity 412.5 may be a quantity of the drug product. For example, “100” 414.5. A quantity qualifier 412.6 may be a qualifier for the quantity 412.5 of the drug product 420. For example, “tablet” 412.6. A dosage form 412.7 may be a dosage form for the drug product 420. NDC number 412.8 may be a NDC number for the drug product. The NDC number may be a unique number that identifies the drug product.

FIG. 5 illustrates an example of a synonym database. A synonym includes a lookup value 510, 530 which is “oral capsule,” and “Amoxicillin 500 mg oral capsule.” And synonyms 520, 540. The synonym database may contain many lookup values 510, 530 and many synonyms 520, 540. As illustrated there are three synonyms for “oral capsule” 510: “capsules” 520.1, “capsule” 520.2, and “oral cap” 520.3. Synonyms may be added to the synonym database by qualified people. The synonym database may be used by the quality engine 150 whenever the quality engine 150 is attempting to find a match and an exact matches is not found for a value such as “oral capsule.” To find acceptable synonyms that may match “oral capsule” the quality engine 150 looks up “oral capsule” in the synonym database and then may use the synonyms found in the synonym database for “oral capsule” such as “oral cap” as a match for “oral capsules.” Also illustrated is a synonym for “Amoxicillin 500 mg oral capsule” 530, which illustrates that phrases may have synonyms, “Amoxicillin 500 mg capsules” 540.1. The synonym database 500 may include synonyms for any of the values for the fields in the electronic prescription 110 and any of the values in the drug product database.

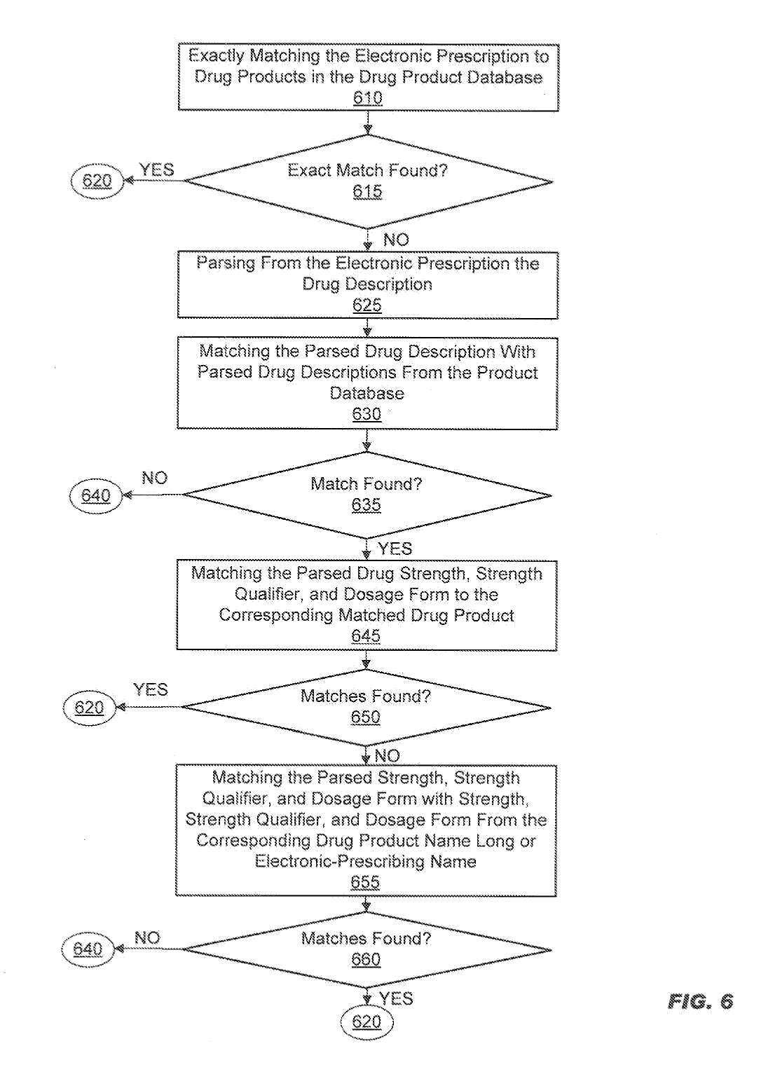

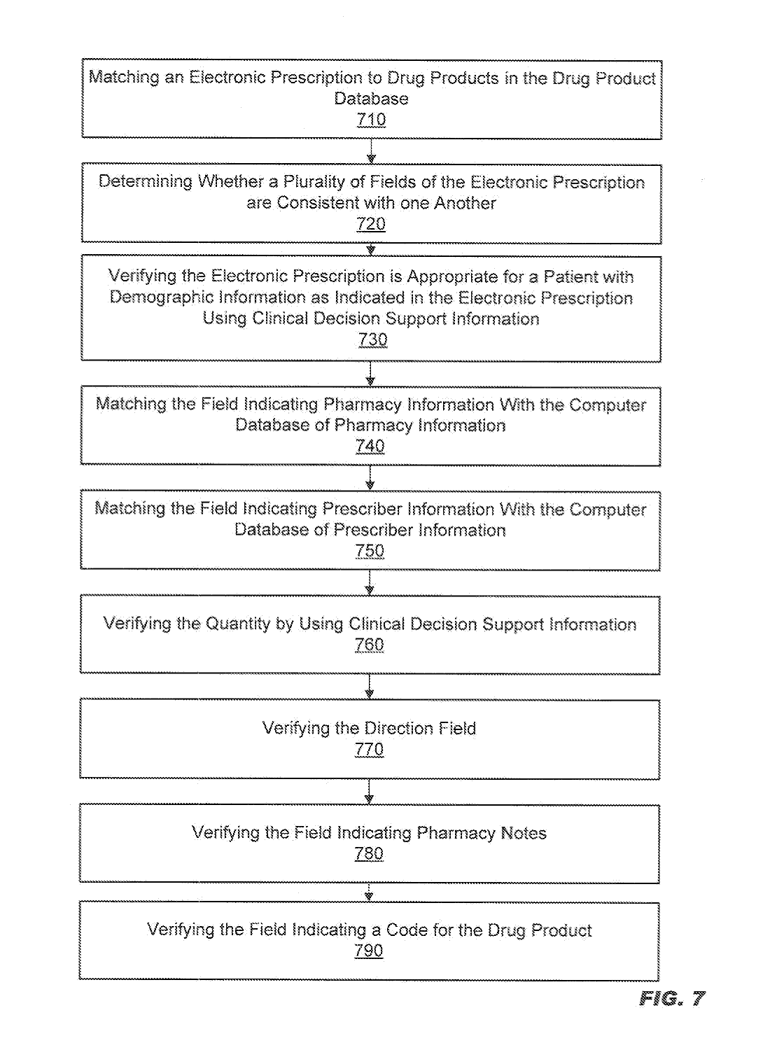

FIG. 6 illustrates an example of a method to match an electronic prescription with a drug product in a drug product database in the reference sources 140 (see FIG. 1). The method may be carried out by the quality engine 150 (see. FIG. 1.) The quality engine 150 is attempting to find out if the electronic prescription 110 (See FIG. 3) matches a drug product (see FIG. 4) in a database of drug products in the reference sources 140. Because the electronic prescription 110 may have been entered with free text and may not be in a precise form, the quality engine 150 may not be able to directly match the electronic prescription 110 to a drug product 420, and may attempt to perform matches that are not exact matches, and may use the synonym database.

The method begins with exactly matching the electronic prescription to drug products in the drug product database 610. The quality engine (see FIG. 1) may attempt to exactly match the electronic prescription 110 (FIG. 3) to a database of drug products 420 (FIG. 4) in the reference sources 140 (see FIG. 1). Note only a single drug product 420 is illustrated in FIG. 4, whereas many thousands would be included in a drug product 420 database. For example, the quality engine 150 may match the prescription 312.1 (FIG. 3), “Amoxicillin 500 mg oral capsule”, to the product name long 412.1 (FIG. 4), “Amoxicillin 500 mg oral capsule.” In this case there is an exact match, so the quality engine 150 may determine that since the two fields matched exactly that the electronic prescription 110 matches the drug product 420.

If there had not been an exact match between the electronic prescription 312.1 and the product name long 412.1, then the quality engine 150 may attempt to match the electronic prescription 312.1 with the electronic prescribing name 412.2, which may be a synonym for the product name long 412.1. For example, if the electronic prescription 312.1 had been “Amoxicillin 500 mg oral cap” (note “capsule” is changed to “cap”) then the quality engine would match the electronic prescription 312.1 to the electronic prescribing name 412.2 (“Amoxicillin 500 mg oral cap”), and an exact match would be found to the electronic prescribing name 412.2. The quality engine 150 may determine that since the electronic prescription 312.1 and the electronic prescribing name 412.2 exactly matched, that the electronic prescription 110 matched the drug product 420.

When attempting to match two fields, the quality engine may take out all or some of the spaces in the electronic prescription 110 and/or fields of the drug product 420. Additionally, the quality engine 150 may ignore capitalization. In embodiments, the quality engine 150 may look for minor spelling errors. In embodiments, where the database of drug products is represented in a relationship database, the quality engine may form structured queries using a structured query language and submit the structured queries to a database engine to check for a match. Moreover, if an exact match is not found between the electronic prescription 310.1 and the drug product database, then the quality engine 150 may use the synonym database to check for a match. For example, if the electronic prescription 110 were “Amoxicillin 500 mg capsules” and the product name long 414.1 were “Amoxicillin 500 mg oral capsule” then there would not be an exact match. The quality engine 150 may look up “Amoxicillin 500 mg oral capsule” in the synonym data 500 and find a match 530 with a synonym 540.1 of “Amoxicillin 500 mg capsules.” Since a synonym of the product name long 414.1 matches the electronic prescription 110 the quality engine may determine this to be a match.

The method proceeds to exact match found 615. If an exact match is found, then the method ends 620 with the quality engine returning an indication that a drug product 420 in the drug product database matched the electronic prescription 110 and the method may return which of the drug products 420 matched the electronic prescription 110. If an exact match was found with the synonym database, then the quality engine may return an indication that a drug product 420 in the drug product database matched the electronic prescription 110, and the quality engine may return that the entry “Amoxicillin 500 mg oral capsule” 414.1 in the drug product database was matched to the electronic prescription 110 through the synonym database with “Amoxicillin 500 mg capsules.”

If no exact match was found, the method continues with parsing from the electronic prescription the drug description 625. For example, if the electronic prescription 110 were “amoxicillin 500 mg oral capsule” 314.1 then the quality engine 150 would parse “amoxicillin” from the electronic prescription 110. The quality engine 150 may parse the drug description from the electronic prescription by locating the first numeric character in the text string from the left. And, if a valid strength qualifier unit follows the numeric character, then assume the first number character is the strength. So, for example, in the string “amoxicillin 500 mg oral capsule,” the string would be scanned from the left until reaching “500.” Then the quality engine would scan “mg” and determine that since “mg” is a valid strength qualifier, that “500” is the strength and “amoxicillin” is the drug description. The characters to the right of “mg”, which are “oral capsule” may be determined to be the dosage form.

The method continues with matching the parsed drug description with drug descriptions from the product database 630. The quality engine 150 matches the parsed drug description, “amoxicillin” in this case to the drug descriptions of the product database. Each of the drug products 420 in the drug product database may need to be parsed in a similar fashion as the electronic prescription 314.1 to create drug descriptions for matching. The quality engine 150 may also attempt to match the drug description with the synonym database which may contain synonyms for drug descriptions in the drug product database.

The method continues with match found 635. If a match between the parsed drug description from the electronic prescription was not found then the method may terminate with no match between the electronic prescription and the product database 640.

If a match between the parsed drug description from the electronic prescription was found, then the method may continue with matching the parsed drug strength, strength qualifier, and dosage form to the corresponding matched drug product 645. FIG. 4 may be one combination of the strength, strength qualifier, and dosage form, for “amoxicillin.” The matched drug description (“amoxicillin” in this example) in the drug product database may have associated with it all the combinations of strength, strength qualifier, and dosage form for all the drug products 420 with the matched drug description, “amoxicillin”. The quality engine 150 would attempt to match the parsed drug strength, strength qualifier, and dosage form to all the combinations for the matched drug description in the drug product database Continuing with the example above, for the electronic prescription 110 with a value of “amoxicillin 500 mg oral capsule” 314.1, the parsed strength is “500,” the parsed strength qualifier is “mg,” the parsed dosage form is “oral capsule.” So, the parsed strength “500” would match 414.3 “500”; the parsed strength qualifier “mg” would match 414.4 “mg”; and, the parsed dosage form “oral capsule” would match 414.7 “oral capsule.” So, since the electronic prescription 110 was able to be parsed and then matched to a drug product 420, the quality engine 150 determines that the electronic prescription 110 matches this drug product 420.

If a match failed between the parsed strength, strength qualifier, or dosage and the corresponding matched drug product, then the quality engine 150 may attempt to match each of the parsed fields with the synonym database and then attempt to match each of the synonyms with the corresponding matched drug product.

The method continues with matches found 650. If the parsed strength, strength qualifier, and dosage matched the corresponding matched drug product either directly or through the synonym database, then the method ends indicating that a match was found and the particulars of how the match was found 620.

If the parsed strength, strength qualifier, and dosage did not match the corresponding matched drug product, then the method may continue with matching the parsed strength, strength qualifier, and dosage form with strength, strength qualifier, and dosage form from the corresponding drug product name long or electronic-prescribing name 655.

In the example above, the electronic prescription 110 has a value of “amoxicillin 500 mg oral capsule” 314.1. The parsed values are then parsed strength: “500,” parsed strength qualifier: “mg,” and parsed dosage form: “oral capsule.” The corresponding fields would be parsed from the drug product 420 field that matched the drug name “amoxicillin.” So, “amoxicillin 500 mg oral capsule” 414.1 would be parsed from the drug product database. Since all the fields match, the quality engine 150 may determine that there is a match. Additionally, if a match failed between the fields in 314.1 and the parsed strength, strength qualifier, and dosage, then a match would be tested between the field 314.2, since it also has “amoxicillin”. Moreover, the quality engine 150 may use the synonym database to see if there is not a direct match that a synonym may match. For example, if the electronic prescription has a value of “amoxicillin 500 mg oral cap,” then the dosage form “oral cap” would not match 414.1 “oral capsule.” But, the quality engine 150 may look up “oral capsule” in the synonym database 500 and determine that “oral cap” is a synonym for “oral capsule” and count “oral cap” as a match to “oral capsule.”

The method continues with match found 660. If a match was found between the parsed fields and the corresponding matched drug product, then the method terminates indicating that a match was found and may indicate how the match was found 620. If a match was not found, then the method terminates with an indication that no match was found 640. Each of the steps illustrates in FIG. 6 may be optional and the steps may be carried out in a different order.

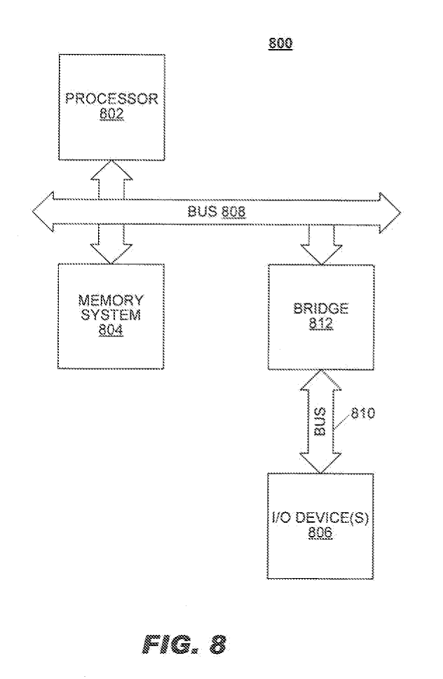

FIG. 7 illustrates an example of a method for determining whether or not the electronic prescription meets a quality standard for each of a plurality of quality issues and generating a quality scorecard to indicate whether or not the electronic prescription met the quality standard for each of the plurality of quality issues. The method begins with matching an electronic prescription to drug products in the drug product database 710. The first quality issue may be whether or not the electronic prescription matches a drug product in the drug product database, and the first quality standard may be that the electronic prescription has to match a drug product in the drug product database. The method discussed in relation to FIG. 6 could be used for the matching. The result of the matching may be indicated on a scorecard for the electronic prescription.

The method continues with determining whether a plurality of fields of the electronic prescription are consistent with one another 720. The second quality issue may be whether a plurality of fields of the electronic prescription are consistent with one another The following are examples of testing whether or not the plurality of fields are consistent with one another. The prescription 312.1 (see FIG. 3) contains a drug name, strength, strength qualifier, and dosage form. Parsing the prescription 312.1 to get these individual fields is discussed above. The electronic prescription 110 also may contain fields where the strength 312.2, strength qualifier 312.3, and dosage form 312.4 are optionally included as separate fields. As an example, in the prescription 110 that is illustrated in FIG. 3, the parsed drug name is “amoxicillin”, the parsed strength is “500”, the parsed strength qualifier is “mg,” and the parsed dosage form is “oral capsule.” These parsed values may be tested with additional fields strength 312.2, strength qualifier 312.3, and dosage form 312.4 to insure they are consistent with one another. In the example of FIG. 3, parsed strength “500” is equal to “500” 314.2, parsed strength qualifier “mg” is equal to “mg” 314.3, and parsed dosage form “oral capsule” is equal to “Oral capsule” 314.4. As another example, the direction field 312.8 may include “take 1 every four hours” 314.8 and the “days supply” 312.16 may be “10” 314.16 days, then the quality engine 150 may insure that the quantity 314.5 is “60” so that the patient would have a 10 day supply of the drug. The scorecard may be marked to indicate whether the plurality of fields is consistent with one another. In testing to insure fields are consistent with one another, the synonym table 500 may be used and field values may be substituted with synonyms from the synonym table 500 to determine whether or not fields are consistent with one another.

The method may continue with verifying the electronic prescription is appropriate for a patient with demographic information as indicated in the electronic prescription using decision support information 730. The third quality issue may be whether or not the electronic prescription is appropriate for a patient with demographic information as indicated in the electronic prescription. The third quality standard may be that the electronic prescription has to be appropriate for the patient. For example, patient demographic information may be included in the electronic prescription. In FIG. 3 the gender 312.12 has a value of “Female” 314.12, and “Date of Birth” 312.13 has a value of “Jul. 2, 1983” 314.13. Clinical decision support information contained in the reference sources 140 can be accessed to determine whether or not the electronic prescription is appropriate for a patient with this demographic information. The scorecard may be marked to indicate whether or not the electronic prescription is appropriate for the patient's demographic information.

The method may continue with matching the field indicating pharmacy information with the computer database of pharmacy information 740. The fourth quality issue may be whether or not the pharmacy information in the electronic prescription matches a database of pharmacy information. The fourth quality standard may be that pharmacy information must match pharmacy information in a database of pharmacy information. The electronic prescription 110 may include information of which pharmacy 312.10 or fulfillment center to forward the electronic prescription. The pharmacy 312.10 may be a number indicating the pharmacy 312.10 that may be used to access information from a database of pharmacy information. The scorecard may be marked to indicate whether or not the pharmacy information 314.10 matches a database of pharmacy information. In embodiments, partial matches may meet the quality standard. For example, minor differences such as a slightly incorrect street address may meet the quality standard.

The method may continue with matching the field indicating prescriber information with the computer database of prescriber information 750. The fifth quality issue may be whether or not the prescriber information in the electronic prescription matches a database of prescriber information. The quality standard may be that the prescriber information in the electronic prescription must match prescriber information in a database of prescriber information. The electronic prescription 110 may include information of which prescriber 312.11, for example a doctor, the electronic prescription came from. The prescriber 312.11 may be a number indicating the prescriber 312.11 that may be used to access information from a database of prescriber information. The scorecard may be marked to indicate whether or not the prescriber information 314.11 matches a database of prescriber information in the reference sources 140.

The method may continue with verifying the quantity by using clinical decision support information 760. The sixth quality issue may be whether or not the quantity in the electronic prescription is appropriate. The quality standard may be that the quantity has to be appropriate. The electronic prescription 110 may include information of a quantity 312.5. The clinical decision support information may include information for appropriate quantities of a drug products. The quality engine 150 may use determine whether or not the quantity 312.5 is appropriate or not. The scorecard may be marked to indicate whether or not the quantity 310.5 is appropriate by using decision support information.

The method may continue with verifying the direction field 770. The seventh quality issue may be whether or not the field indicating directions 312.8 in the electronic prescription 110 is appropriate. The seventh quality standard may be that the field indicating directions 312.8 must be appropriate. The electronic prescription 110 may include directions such as “Take 1 every four hours” 314.8. The quality engine may use the NLP engine to parse the directions 314.8 to ensure that the directions are a simple understandable sentence. For example, the NLP engine may separate out the subject, verb, and object as well as nouns and qualifiers. The quality engine may then match the parsed directions 314.8 against a list of common directions to determine whether or not the directions 314.8 are appropriate. For example, “take” is a verb, and “1 every four hours” is an adverbial phrase. The object of the verb is missing and would be implied to be “one oral capsule”, although the fact that the object of the verb is not explicit may raise a quality issue. The quality engine may also search all the words in the directions 314.8 to insure that a latin word has not been used. The NLP engine may check to see if any non-pertinent or non-clinical data is included in this field that should either not be sent in the prescription or should have been sent in another field. For example, sending quantity information in the directions field instead of the field specifically designated for quantity (See FIG. 3 312.5). The scorecard may be marked to indicate whether or not the directions are appropriate.

The method may continue with verifying the field indicating pharmacy notes 780. The eight quality issue may be whether or not the pharmacy notes 310.9 in the electronic prescription are appropriate. The eight quality standard may be that the pharmacy notes 310.9 in the electronic prescription are appropriate. The electronic prescription 110 may include pharmacy notes 312.9. The quality engine may use the NLP engine to parse the pharmacy notes 312.9 to insure that the pharmacy notes 312.9 are appropriate. For example, the quality engine may check to insure that the pharmacy notes 312.9 contain only additional prescriber instructions to the pharmacy and not notes intended for the patient. The quality engine may use clinical decision support information to insure the pharmacy notes are appropriate. The NLP engine may check to see if any non-pertinent or non-clinical data is included in this field that should either not be sent in the prescription or should have been sent in another field. For example, sending quantity information in the pharmacy notes 312.9 instead of the field specifically designated for quantity (See FIG. 3 312.5). The scorecard may be marked to indicate whether or not the pharmacy notes are appropriate. The quality standard may be whether or not the pharmacy notes are appropriate or not.

The method may continue with verifying the field indicating a code for the drug product 790. For example, the code may be a national drug code (NDC) number. The tenth quality issue may be whether or not a code for the drug product is verified. The tenth quality standard may be that the code for the drug product must be verified. As an example, an ID number 312.15 may be included with the electronic prescription 110 and this number 312.15 may be tested to insure that it matches the NDC number 412.6 of the matched drug product. The scorecard may be marked to indicate whether or not the field indicating a code for the drug product is verified.

The method may then end. In the method of FIG. 7 each of the steps is optional and the steps may be performed in a different order.

FIG. 8 is a simplified functional block diagram of a computer system 800. The quality control system can be implemented in hardware, software or some combination thereof.

As shown in FIG. 8, the computer system 800 includes a processor 802, a memory system 804 and one or more input/output (I/O) devices 806 in communication by a communication ‘fabric.’ The communication fabric can be implemented in a variety of ways and may include one or more computer buses 808, 810 and/or bridge devices 812 as shown in FIG. 8. The I/O devices 806 can include network adapters and/or mass storage devices. Referring to FIGS. 1 and 8, the computer system 800 may receive electronic prescriptions 110 over the network adapters 806 for quality control checking and can forward the electronic prescriptions over the network adapters 806 after performing quality control checking. The quality issues 120, quality standards 130, reference sources 140, quality engine 150, minimum quality standard 160, quality scorecard 170 may reside on memory system 804 and/or on I/O devices 806. For example, the reference sources 140 may include a database of drug products. The database may be organized and accessible according to commercial available database products. The database of drug products may reside on a mass storage device that is part of the memory system 804, or may reside on a mass storage device that is accessible via the communication fabric and part of the I/O devices 806, which may be either local such as a hard disk in the same room as the processor 802 or may be located remotely such as in a memory system such as a hard disk remotely located in a service center. The communication fabric may be in communication with many networks including the Internet and local area networks. The quality control system 100 may forward the electronic prescription 110 for review 190 either locally or remotely over the communication fabric.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium, which may be in a physical form.

Although described in connection with preferred embodiments thereof, it will be appreciated by those skilled in the art that additions, deletions, modifications, and substitutions not specifically described may be made without departure from the spirit and scope of the invention as defined in the appended claims.

What is claimed is:

1. A method on a computer for quality control checking of electronic prescriptions, the method comprising:
receiving an electronic prescription,
determining whether or not the electronic prescription meets a quality standard for each of a plurality of quality issues and generating a quality scorecard to indicate whether or not the electronic prescription meets the quality standard for each of the plurality of quality issues; and
if the scorecard indicates the electronic prescription meets a minimum quality standard then forwarding the electronic prescription across a computer network for fulfillment,
otherwise if the scorecard indicates the electronic prescription does not meet a minimum quality standard forwarding the electronic prescription for review.

2. The method of claim 1, wherein otherwise if comprises:
forwarding the electronic prescription for review; and
forwarding the electronic prescription for fulfillment.

3. The method of claim 1, wherein otherwise if comprises:
forwarding the electronic prescription for review; and
forwarding the electronic prescription back to at least one of the prescriber or a prescriber technology vender with an indication that the electronic prescription did not meet at least one quality standard.

4. The method of claim 1, wherein otherwise if comprises:
forwarding the electronic prescription for review; and
forwarding the electronic prescription in real time to an expert to assess whether or not to forward the electronic prescription for fulfillment.

5. The method of claim 1, wherein one of the plurality of quality issues is whether or not the electronic prescription matches a drug product in a drug product database, and wherein the method further comprises:
determining whether the electronic prescription matches a drug product in a drug product database; and
marking the scorecard to indicate whether a match was found.

6. The method of claim 1, wherein the electronic prescription includes a plurality of fields, and wherein one of the plurality of quality issues is whether or not the plurality of fields is consistent, and wherein the method further comprises:
determining whether the plurality of fields is consistent with one another; and
marking the scorecard to indicate whether the plurality of fields is consistent with one another.

7. The method of claim 1, wherein the electronic prescription includes a free text description field and a drug strength field, and wherein one of the plurality of quality issues is whether or not the drug strength field matches a drug strength in the free text drug description field, and wherein the method further comprises:
verifying that the drug strength field matches the drug strength in the free text drug description field; and
marking the scorecard to indicate whether the drug strength field matches the drug strength in the free text drug description field.

8. The method of claim 1, wherein the electronic prescription includes a free text description field and a drug strength qualifier field, and wherein one of the plurality of quality issues is whether or not the drug strength qualifier field matches a drug strength qualifier in the free text drug description field and wherein the method further comprises:
verifying that the drug strength qualifier field matches the drug strength qualifier in the free text drug description field; and
marking the scorecard to indicate whether the drug strength qualifier field matches the drug strength qualifier in the free text drug description field.

9. The method of claim 1, wherein the electronic prescription includes a free text description field and a drug dosage form field and wherein one of the plurality of quality issues is whether or not the drug dosage form field matches a drug dosage form in the free text drug description field, and wherein the method further comprises:
verifying that the drug dosage form field matches the drug dosage form in the free text drug description field; and
marking the scorecard to indicate whether the drug dosage form field matches the drug dosage form in the free text drug description field.

10. The method of claim 1, wherein the electronic prescription includes a free text description field and a quantify qualifier field and wherein one of the plurality of quality issues is whether or not a quantity qualifier field matches a drug dosage form in the free text drug description field; and wherein the method further comprises:
verifying that the quantity qualifier field matches the drug dosage form in the free text drug description field, wherein a synonym database may be used to determine whether or not the quantity qualifier field matches the drug dosage form; and
marking the scorecard to indicate whether the quantify qualifier field matches the drug dosage form in the free text drug description field.

11. The method of claim 1, wherein the electronic prescription includes a free text description field and a generic-brand field and wherein one of the plurality of quality issues is whether or not the generic-brand field is consistent with a drug name in the free text drug description field, and wherein the method further comprises:
verifying that the generic-brand field is consistent with the drug name in the free text drug description field; and
marking the scorecard to indicate whether the generic-brand field is consistent with the drug name in the free text drug description field.

12. The method of claim 1, wherein the electronic prescription includes at least one field indicating demographic information of the patient, and wherein one of the plurality of quality issues is whether or not the electronic prescription is appropriate for the at least one field indicating demographic information of the patient, and wherein the method further comprises:
verifying that the electronic prescription is appropriate for the at least one field indicating demographic information of the patient by using clinical decision support information; and
marking the scorecard to indicate whether the electronic prescription is appropriate for the at least one field indicating demographic information of the patient by using clinical decision support information.

13. The method of claim 12, wherein the at least one field indicating demographic information of the patient includes at least one of patient age and patient sex.

14. The method of claim 1, wherein the electronic prescription includes a field indicating pharmacy information for fulfilling the electronic prescription, and wherein one of the plurality of quality issues is whether or not the field indicating pharmacy information matches a computer database of pharmacy information, and wherein the method further comprises:
matching the field indicating pharmacy information with the computer database of pharmacy information; and
marking the scorecard to indicate whether the field indicating pharmacy information matches pharmacy information in the database of pharmacy information.

15. The method of claim 1, wherein the electronic prescription includes a field indicating prescriber information, and wherein one of the plurality of quality issues is whether or not the field indicating prescriber information matches a computer database of prescriber information, and wherein the method further comprises:
matching the field indicating prescriber information with the computer database of prescriber information; and
marking the scorecard to indicate whether the field indicating prescriber information matches prescriber information in the database of prescriber information.

16. The method of claim 1, wherein the electronic prescription includes a field indicating quantify information, and wherein one of the plurality of quality issues is whether or not the quantify information is appropriate, and wherein the method further comprises:
verifying the quantify information is appropriate by using clinical decision support information; and
marking the scorecard to indicate whether the quantify information is appropriate.

17. The method of claim 1, wherein one of the plurality of quality issues is whether or not a quantity of the electronic prescription is appropriate, and wherein the method further comprises:
determining the quantity of the electronic prescription;
verifying the quantity by using clinical decision support information; and
marking the scorecard to indicate whether the quantity is appropriate.

18. The method of claim 1, wherein the electronic prescription includes a field indicating directions for use, and wherein one of the plurality of quality issues is whether or not the directions for use is appropriate and the method further comprises:
verifying the field indicating directions does not include Latin words; and
marking the scorecard to indicate whether the field indicating directions for use is appropriate.

19. The method of claim 1, wherein the electronic prescription includes a field indicating directions for use, and wherein one of the plurality of quality issues is whether or not the directions are appropriate, and the method further comprises:
parsing a field indicating directions to verify the directions are appropriate for the electronic prescription using NLP; and
marking the scorecard to indicate whether the field indicating directions for use is appropriate.

20. The method of claim 1, wherein the electronic prescription includes a field indicating notes for a pharmacy, and wherein one of the plurality of quality issues is whether or not the notes for the pharmacy are appropriate for the electronic prescription, and the method further comprises:
parsing the field indicating notes for a pharmacy to verify the notes are appropriate for the electronic prescription; and
marking the scorecard to indicate whether the field indicating notes for a pharmacy is appropriate for the electronic prescription.

21. The method of claim 20, wherein parsing further comprises:
parsing the field indicating notes for a pharmacy using natural language processing to verify the notes only contain additional prescriber instructions to the pharmacy.

22. The method of claim 5, wherein determining further comprises:
if a match is not found, matching the electronic prescription to one of a plurality of synonyms for drug products in the drug product database.

23. The method of claim 2, wherein forwarding the electronic prescription for fulfillment, comprises:
forwarding the electronic prescription for fulfillment with an indication that the electronic prescription did not met at least one quality standard.

24. The method of claim 1, further comprising:
creating a report indicating the number of electronic prescriptions that met a minimum quality standard and the number of electronic prescriptions that did not meet a minimum quality standard and the report indicating which of the quality issues did not met the corresponding quality standard.

25. The method of claim 5, wherein determining whether the electronic prescription matches comprises:
determining whether the electronic prescription matches a drug product in a drug product database, wherein the drug products in the drug product database are associated with unique National Drug Code (NDC) numbers.

26. The method of claim 1, wherein the electronic prescription is received over a computer network.

27. The method of claim 1, wherein forwarding comprises:
forwarding the electronic prescription over a computer network for fulfillment.

28. A computer program product, comprising:
a computer-readable medium comprising:
a first set of codes for receiving from a computer network an electronic prescription;
a second set of codes for determining whether or not the electronic prescription meets a quality standard for each of a plurality of quality issues;
a third set of codes for generating a quality scorecard to indicate whether or not the electronic prescription meets the quality standard for each of the plurality of quality issues; and
a fourth set of code for forwarding the electronic prescription across a computer network for fulfillment, if the scorecard indicates the electronic prescription meets a minimum quality standard; and
a fifth set of code for forwarding the electronic prescription for review, if the scorecard indicates the electronic prescription does not meet a minimum quality standard.

29. A computer system for quality control checking of electronic prescriptions, the system comprising:
a process adapted to:
receive from a computer network an electronic prescription;
determine whether or not the electronic prescription meets a quality standard for each of a plurality of quality issues;
generate a quality scorecard to indicate whether or not the electronic prescription met the quality standard for each of the plurality of quality issues;
forward the electronic prescription across a computer network for fulfillment if the scorecard indicates the electronic prescription meets a minimum quality standard; and
forward the electronic prescription for review, if the scorecard indicates the electronic prescription does not meet a minimum quality standard.

30. The computer system of claim 29, wherein one of the plurality of quality issues is whether or not the electronic prescription matches one of a plurality of stored descriptions of electronic prescriptions, and wherein the process is further adapted to:
determine whether the electronic prescription matches one of a plurality of stored descriptions of electronic prescriptions; and
mark the scorecard to indicate whether a match was found.

31. The computer system of claim 29, wherein the electronic prescription includes a plurality of fields, and wherein one of the plurality of quality issues is whether or not the plurality of fields is consistent, and wherein the processor is further adapted to:
determine whether the plurality of fields is consistent with one another; and
mark the scorecard to indicate whether the plurality of fields is consistent with one another.

32. A method on a computer for quality control checking of electronic prescriptions, the method comprising:
receiving an electronic prescription,
determining whether or not the electronic prescription meets a quality standard for each of a plurality of quality issues and generating a quality scorecard to indicate whether or not the electronic prescription meets the quality standard for each of the plurality of quality issues; and
creating a report indicating the number of electronic prescriptions that met a minimum quality standard and the number of electronic prescriptions that did not meet a minimum quality standard and the report indicating which of the quality issues did not met the corresponding quality standard.
